(19) United States
(12) Patent Application Publication
(10) Pub. No.: US 2007/0040789 A1
(43) Pub. Date: Feb. 22, 2007

(54) Protection device for gate integrated circuit, gate driver, liquid crystal display including the same and method of protecting a gate IC in a display

(75) Inventor: Young-suk Ha, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/506,315

(22) Filed: Aug. 17, 2006

(30) Foreign Application Priority Data
Aug. 17, 2005 (KR) 10-2005-0075314
Apr. 14, 2006 (KR) 10-2006-0034190

(51) Int. Cl. G09G 3/36

(52) U.S. Cl. 345/98

(57) ABSTRACT

A gate IC protection device that protects a gate IC from damage and allows image to be generated normally even when an abnormal vertical synchronization start signal is received is presented, along with a gate driver and a liquid crystal display employing the gate IC protection device. A method of protecting a gate IC in a display device is also presented. The gate IC protection device includes a vertical synchronization start signal converting unit and a signal delay unit. The vertical synchronization start signal converting unit receives a first vertical synchronization start signal and a level control signal, performs a predetermined logic operation thereon, and outputs a second vertical synchronization start signal. The signal delay unit receives the second vertical synchronization start signal and outputs the level control signal that is fed back to the vertical synchronization start signal converting unit in synchronization with a gate clock signal.

### CROSS-REFERENCE TO RELATED APPLICATIONS

This application claims priorities from Korean Patent Application No. 10-2005-0075314 filed on Aug. 17, 2005 and Korean Patent Application No. 10-2006-0034190 filed on Apr. 14, 2006 in the Korean Intellectual Property Office, the contents of which are incorporated herein by reference in their entirety.

### BACKGROUND OF THE INVENTION

1. Field of the Invention

The present invention relates generally to a protection device for a gate integrated circuit (IC), and more particularly to a gate IC protection device that protects a gate IC from an abnormal vertical synchronization start signal STV.

2. Description of the Related Art

A typical liquid crystal display (LCD) includes two substrates and a liquid crystal material having a dielectric anisotropy positioned between the two substrates. Light transmission through the substrates is controlled by varying the strength of the electric field formed between the substrates, thereby controlling the orientation of the liquid crystal material and displaying a desired image.

The LCD includes a liquid crystal panel assembly, a timing controller, and a data driver and a gate driver receiving a plurality of timing signals from the timing controller and driving the liquid crystal panel. The liquid crystal panel assembly includes a plurality of gate lines to which gate ON/OFF signals are applied, a plurality of data lines that extend perpendicularly to the gate lines and to which predetermined data voltages are applied, and a plurality of pixels. The pixels are formed at a pixel area defined by the plurality of gate lines and each of the plurality of data lines.

The timing controller provides the gate driver with a vertical synchronization start signal STV and a gate clock signal CPV. When the vertical synchronization start signal STV is at a high level, a turn-on signal in synchronization with a rising edge of the gate clock signal CPV is applied to a first gate line. After the turned-on first gate line is turned off, the turn-on signal in synchronization with a rising edge of a next gate clock signal CPV is applied to a second gate line. In this way, the turn-on signal is sequentially applied to the plurality of gate lines in synchronization with the rising edges of the gate clock signal CPV. Here, the vertical synchronization start signal STV is kept at a high level during only a period of time taken for a gate line in one frame to be turned on, which is called ‘1H’ and is a signal having one frame duration. In other words, for normal driving of the gate driver, the vertical synchronization start signal STV should be at a high level during only a 1H period while driving one frame, and the gate clock signal should generate a rising edge just one time while the vertical synchronization start signal STV is held high.

Due to any abnormal operation of the timing controller, however, the vertical synchronization start signal STV may be kept at a high level for longer than a period of 1H. Otherwise, when applying the vertical synchronization start signal STV to the gate driver, noise may extend a time in which the vertical synchronization start signal STV is held high to at least 1H.

In a conventional LCD, while the vertical synchronization start signal STV is held high, the gate clock signal generates a plurality of rising edges, causing a plurality of gate lines to be simultaneously switched on and off. A considerable amount of current is consumed during this process, causing damages to the gate driver and disabling a normal image display.

Therefore, it would be desirable to provide a gate IC protection device, a gate driver and a liquid crystal display, which enable normal operation even in an event of receiving an abnormal vertical synchronization start signal STV signal.

### SUMMARY OF THE INVENTION

The present invention provides a gate IC protection device which protects a gate integrated circuit (IC) from an abnormal vertical synchronization start signal STV. The present invention also provides a gate driver that operates normally even if an abnormal vertical synchronization start signal STV is applied thereto. The present invention also provides a liquid crystal display that operates normally even if an abnormal vertical synchronization start signal STV is applied thereto. The present invention also provides a method of protecting a gate IC in a display device even if an abnormal vertical synchronization start signal STV is applied thereto.

In one aspect, the present invention is a gate integrated circuit (IC) protection device including a vertical synchronization start signal converting unit and a signal delay unit. The vertical synchronization start signal converting unit has a first input for receiving a first vertical synchronization start signal and a level control signal, a logic circuit for performing a predetermined logic operation thereon, and a first output for outputting a second vertical synchronization start signal. The signal delay unit has a second input for receiving the second vertical synchronization start signal and a second output for outputting the level control signal that is fed back to the vertical synchronization start signal converting unit in synchronization with a gate clock signal.

In another aspect, the present invention is a gate driver including a vertical synchronization start signal converting unit and a gate integrated circuit. The vertical synchronization start signal converting unit has a first input for receiving a first vertical synchronization start signal and a level control signal, a logic circuit for performing a predetermined logic operation thereon, and a first output for outputting a second vertical synchronization start signal. The gate integrated circuit (IC) has a second input for receiving the second vertical synchronization start signal and a second output for ouputting gate ON/OFF signals in synchronization with a gate clock signal. One of the gate ON/OFF signals is fed back to the vertical synchronization start signal converting unit as the level control signal.

According to yet another aspect, the present invention is provided a liquid crystal display including a timing controller, a gate IC protection device, a gate driver, and a liquid crystal panel assembly. The timing controller produces a first vertical synchronization start signal and a gate clock signal. The gate IC protection device outputs a second vertical synchronization start signal of a logic low when the first vertical synchronization start signal is held high for more than a predetermined time period. The gate driver receives the second vertical synchronization start signal and outputs gate ON/OFF signals in synchronization with the gate clock signal. The liquid crystal panel assembly drives pixels using the gate ON/OFF signals and displaying a predetermined image.

According to yet another aspect, the present invention is a liquid crystal display including a timing controller, a gate driver, and a liquid crystal panel assembly. The timing controller provides a first vertical synchronization start signal and a gate clock signal. The gate driver includes a gate IC protection device outputting a second vertical synchronization start signal of a logic low when the first vertical synchronization start signal is held high for more than a predetermined time period, and outputting gate ON/OFF signals in synchronization with the gate clock signal. The liquid crystal panel assembly drives pixels using the gate ON/OFF signals and displays a predetermined image.

According to yet another aspect, the present invention is a liquid crystal display including a timing controller, a gate driver, and a liquid crystal panel assembly. The timing controller includes a clock generator producing a gate clock signal and a first vertical synchronization start signal and a gate IC protection device outputting a second vertical synchronization start signal of a logic low when the first vertical synchronization start signal is held high for more than a predetermined time period. The gate driver receives the second vertical synchronization start signal and outputs gate ON/OFF signals in synchronization with the gate clock signal. The liquid crystal panel assembly driving pixels uses the gate ON/OFF signals and displays a predetermined image.

In yet another aspect, the invention is a method of protecting a gate IC in a display device. The method includes receiving a first vertical synchronization signal and a level control signal, and performing a logic operation on the two signals to generate a second vertical synchronization start signal. The level control signal is generated using the second synchronization start signal.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram of a gate IC protection device according to an embodiment of the present invention;

FIG. 2 is a circuit diagram of the gate IC protection device shown in FIG. 1;

FIG. 3 is a truth table illustrating an exemplary operation of the gate IC protection device shown in FIG. 2;

FIG. 4 is a diagram illustrating signals associated with the operation of the gate IC protection device shown in FIG. 2;

FIG. 5 is a circuit diagram illustrating a gate driver according to an embodiment of the present invention;

FIG. 6 is a circuit diagram of a gate driver according to another embodiment of the present invention;

FIG. 7 is a block diagram of an LCD according to an embodiment of the present invention; and

FIG. 8 is a block diagram of an LCD according to another embodiment of the present invention.

### DETAILED DESCRIPTION OF THE EMBODIMENTS

The present invention will now be described more fully with reference to the accompanying drawings, in which preferred embodiments of this invention are shown. Advantages and features of the present invention and methods of accomplishing the same may be understood more readily by reference to the following detailed description of the embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

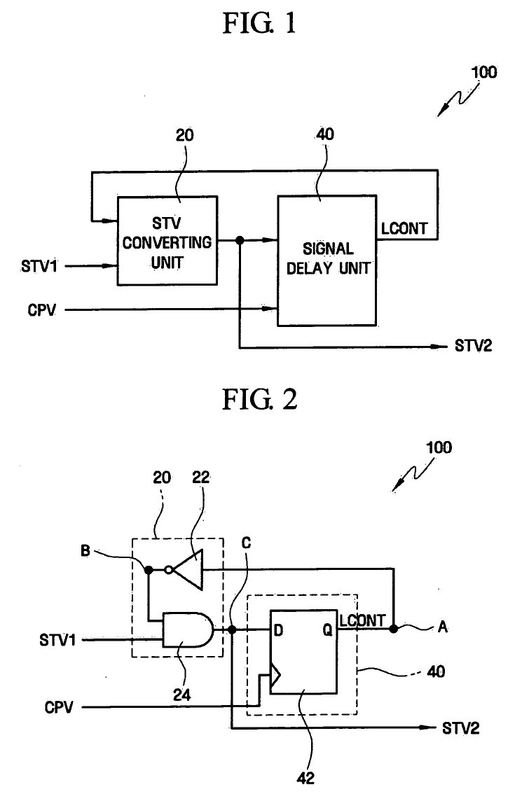

FIG. 1 is a block diagram of a gate IC protection device 100 according to an embodiment of the present invention.

Referring to FIG. 1, the gate IC protection device 100 includes a vertical synchronization start signal (STV) converting unit 20 receiving a first vertical synchronization start signal STV1 and a level control signal LCONT and outputting a second vertical synchronization start signal STV2, and a signal delay unit 40 receiving the STV2 and a gate clock signal CPV and feeding the level control signal LCONT back to the STV converting unit 20.

In detail, the STV converting unit 20 receives the first vertical synchronization start signal STV1 from a timing controller (not shown) and is provided with a level control signal LCONT from the signal delay unit 40. Here, when the first vertical synchronization start signal STV1 is set at a high level during at least a period of time in which one gate line is turned on, i.e. a period of 1H, the STV converting unit 20 converts the level of the first vertical synchronization start signal STV1 and outputs a low level of the second vertical synchronization start signal STV2. The internal circuit and operation of the STV converting unit 20 will be described with reference to FIGS. 2 through 4.

The signal delay unit 40 receives the first vertical synchronization start signal STV1 and feeds the level control signal LCONT back to the STV converting unit 20 in synchronization with the gate clock signal CPV. Here, since the gate clock signal CPV is a signal defined by a period of 1H, the level control signal LCONT corresponds to a 1H delayed signal from the second vertical synchronization start signal STV2. The internal circuit and operation of the signal delay unit 40 will be described with reference to FIGS. 2 through 4.

Even if the first vertical synchronization start signal STV1 is held high for longer than 1H, the second vertical synchronization start signal STV2 being at a low level is provided to the gate driver. The gate driver receives the second vertical synchronization start signal STV2 and outputs the gate ON/OFF signals in synchronization with the gate clock signal CPV.

According to the illustrated gate IC protection device 100, even if the abnormal first vertical synchronization start signal STV1 is provided from the timing controller (not shown), that is, even if the first vertical synchronization start signal STV1 is held high for a time period longer than 1H in one frame and the gate clock signal CPV generates its rising edge at least twice while the first vertical synchronization start signal STV1 is held high, the gate line will not be turned on more than twice in one frame. Accordingly, the gate IC is prevented from being damaged due to an overcurrent condition and a normal image display can be achieved.

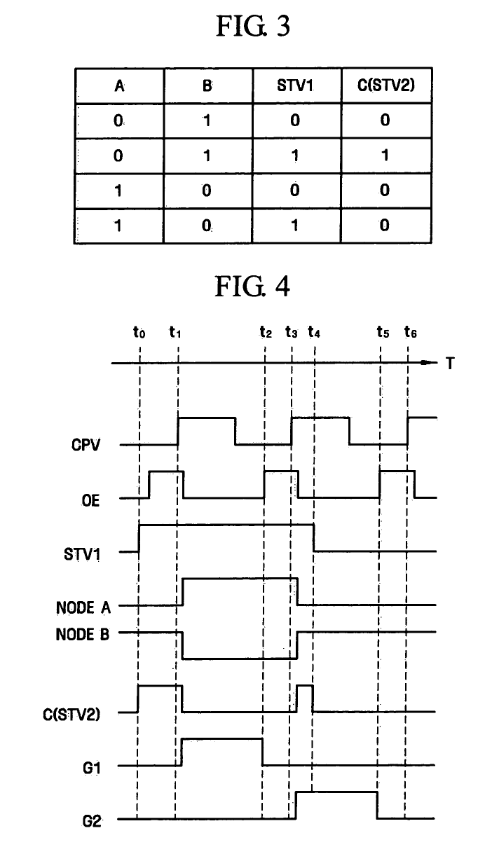

FIG. 2 is a circuit diagram of the gate IC protection device shown in FIG. 1, FIG. 3 is a truth table illustrating an exemplary operation of the gate IC protection device shown in FIG. 2, and FIG. 4 is a diagram illustrating signals associated with the operation of the gate IC protection device shown in FIG. 2.

Referring to FIG. 2, the STV converting unit 20 includes an inverter 22 receiving the level control signal LCONT and inverting the level control signal LCONT, and an AND gate 24 receiving the first vertical synchronization start signal STV1 and outputting the second vertical synchronization start signal STV2. The signal delay unit 40 includes a D-flipflop 42 receiving the first vertical synchronization start signal STV1 and feeding the level control signal LCONT back to the STV converting unit 20 in synchronization with to the gate clock signal CPV.

Referring to FIG. 3 showing a truth table illustrating an exemplary operation of the gate IC protection device, when node A is set at a low level, node B is activated to a high level by the inverter 22. Under these conditions, if the first vertical synchronization start signal STV1 is set at a low level, node C goes low. If the first vertical synchronization start signal STV1 is set at a high level, node C is goes high. Node C is the node through which the second vertical synchronization start signal STV2 is output.

While node C is held high, node A rises to the high level at a rising edge of the gate clock signal CPV, that is, when the gate clock signal CPV makes a transition from a low level to a high level. Accordingly, node B is set at a low level. Under these conditions, even if the first vertical synchronization start signal STV1 maintained a high level during a period of 1H, node C goes low, that is, the second vertical synchronization start signal STV2 of a low level is output.

Thus, a gate line is not turned on more than twice in one frame, which will be described in more detail with reference to FIG. 4.

Various signals applied to the gate lines and levels thereof according to passage of time T are illustrated in FIG. 4. Here, an output enable signal OE controls the amount of time it takes for each gate line to be turned on, reference symbol G1 indicates the level of a “first gate line” that is turned on or off in a frame, and G2 indicates the level of a “second gate line” in the frame that is turned on or off. The present invent will now be described with regard to an exemplary abnormal state wherein the first vertical synchronization start signal STV1 is held at a high level for a time period of more than 1H (t₀˜t₄).

Before time t₀, since node A is set at a low level and node B is set at a high level, and the first vertical synchronization start signal STV1 is at a low level, node C is set at a low level accordingly. In addition, the first gate line G1 and the second gate line G2 are both at low levels, as shown.

At time t₀, if the first vertical synchronization start signal STV1 goes high, the second vertical synchronization start signal STV2 also goes high. This causes node C to be set at a high level because an AND gate 24 receives node B and the first vertical synchronization start signal STV1 as its input. Then, node C outputs the second vertical synchronization start signal STV2. At time t₀, since the gate clock signal CPV is at a low level, the first gate line G1 is at a low level. That is, the first gate line maintains an off state.

At time t₁, if the gate clock signal CPV makes a transition from a low level to a high level, the first gate line G1 goes high. In detail, since the second vertical synchronization start signal STV2 is at a high level at the rising edge of the gate clock signal CPV, the first gate line G1 is turned on. In addition, since the D-flipflop (42 of FIG. 2) operates in synchronization with the gate clock signal CPV, node A goes high and node B goes low. At this time, the first STV signal is at a high level and node C goes low.

At time t₂, if the output enable signal OE makes a transition from a low level to a high level, the first gate line G1 goes low. That is, the first gate line is turned off at the rising edge of the output enable signal OE.

At time t₃, if the gate clock signal CPV makes a transition from a low level to a high level, the second gate line G2 goes high. In detail, since the second vertical synchronization start signal STV2 is at a low level at the rising edge of the gate clock signal CPV, the first gate line G1 is held low. That is, the first gate line maintains an off state. The second gate line G2 is turned on by a shift register (not shown) operating in synchronization with the gate clock signal CPV. In addition, since the D-flipflop (42 of FIG. 2) operates in synchronization with the gate clock signal CPV, node A goes low and node B is activated to a high level by the inverter (22 of FIG. 2). At this time, the first STV signal is at a high level and node C goes high.

At time t₄, if the first vertical synchronization start signal STV1 goes low, the level of node C is stepped down to a low level by the AND gate (24 of FIG. 2).

At time t₅, if the output enable signal OE makes a transition from a low level to a high level, the level of the second gate line G2 steps down. That is, the second gate line is turned off at the rising edge of the output enable signal OE.

At time t₆, the gate clock signal CPV makes a transition from a low level to a high level. At this time, since the second vertical synchronization start signal STV2 is held low, the first gate line G1 is held low. That is, the first gate line maintains an off state.

In a normal state, the first vertical synchronization start signal STV1 is not held at a high level for longer than 1H (t₀˜t₄). However, even in an abnormal state where the first vertical synchronization start signal STV1 stays high longer due to a malfunction of a timing controller (not shown) or occurrence of noises, the first vertical synchronization start signal STV1 is converted to the second vertical synchronization start signal STV2 as described above.

Accordingly, with the above method, the gate line will not be turned on more than twice in one frame. This way, it is possible to prevent the gate IC from being damaged due to an overcurrent condition and a normal image display can be achieved.

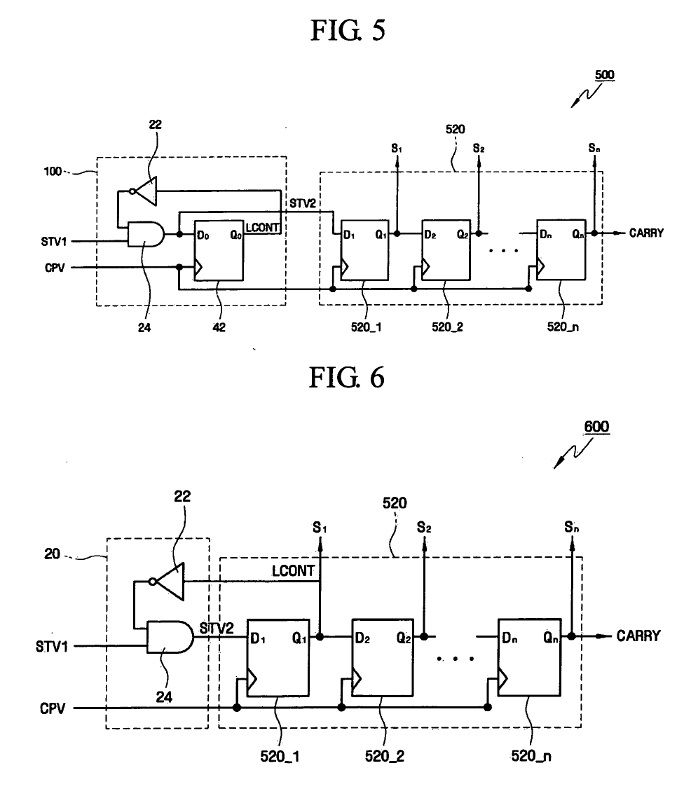

FIG. 5 is a circuit diagram illustrating a gate driver 500 according to an embodiment of the present invention.

Referring to FIG. 5, the gate driver 500 includes the gate integrated circuit (IC) protection device 100 and a gate IC 520. The gate IC protection device 100, which may be the same as what is described above in reference FIGS. 1 through 4, is incorporated in the gate driver 500. To avoid redundant description, detailed description of the reference numerals that are given to the elements performing the same functions as those shown in FIG. 2 will be omitted.

The gate IC 520 receives a second vertical synchronization start signal STV2 from the gate IC protection device 100 in synchronization with a gate clock signal CPV and provides gate ON/OFF signals to a plurality of gate lines (not shown). The gate IC 520 includes a plurality of shift registers and the present invention will be described with regard to a plurality of D-flipflops by way of example.

The plurality of D-flipflops 520_1, 520_2, . . . , and 520_n coupled to the plurality of gate lines (not shown) provide the plurality of gate lines with gate ON/OFF signals S₁, S₂, . . . , and Sn, respectively. That is to say, the first D-flipflop 520_1 provides the first gate ON/OFF signal S1 to the first turned-on gate line in a frame and the nth D-flipflop 520_n provides the nth gate ON/OFF signal Sₙ to the nth turned-on gate line in the frame while providing a carry signal CARRY to the next gate IC (not shown). In this way, the plurality of D-flipflops 520_1, 520_2, . . . , and 520_n are arranged such that the output of a corresponding D-flipflop of a previous stage is applied to the next D-flipflop as its input to sequentially provide the gate ON/OFF signals S₁, S₂, . . . , and Sₙ in synchronization with the gate clock signal CPV. While the shift register shown in FIG. 5 comprises n D-flip-flops 520_1, 520_2, . . . , and 520_n, the invention is not limited thereto and the shift register according to the present invention may comprise a plurality of logical operators to output and transmit input data using a predetermined clock signal CPV.

Since the gate IC protection device 100 is incorporated in the gate driver 500, the gate IC 520 is protected from damage and a normal image display can be achieved even if the first vertical synchronization start signal STV1 is received in an abnormal state.

FIG. 6 is a circuit diagram of a gate driver 600 according to another embodiment of the present invention.

Referring to FIG. 6, the gate driver 600 includes an STV converting unit 20 and a gate IC 520. The gate driver 600 is different from with the gate driver 500 shown in FIG. 5 in that the signal delay unit 40 of FIG. 1 does not use a separate D-flipflop but uses one among a plurality of D-flipflops provided in the gate IC 520. In the illustrative embodiment shown in FIG. 6, the signal delay unit 40 of FIG. 1 corresponds to the first D-flipflop 520_1. To avoid redundant description, detailed description of parts with reference numerals that are given to the elements performing the same functions as those shown in FIGS. 2 and 5 will be omitted.

The gate IC 520 includes a plurality of D-flipflops 520_1, 520_2, . . . , and 520_n operating in synchronization of a gate clock signal CPV. The first D-flipflop 520_1 receives a second vertical synchronization start signal STV2 and outputs a level control signal LCONT, which is then fed back to the STV converting unit 20. Here, the plurality of D-flipflops 520_1, 520_2, . . . , and 520_n coupled to a plurality of gate lines (not shown) provide the plurality of gate lines with gate ON/OFF signals S₁, S₂, . . . , and Sₙ, respectively. That is, a level control signal LCONT is a gate ON/OFF signal S₁ that is provided to the first turned-on gate line in one frame.

Even if the first vertical synchronization start signal STV1 is received in an abnormal state, since the gate driver 600 generates the second vertical synchronization start signal STV2 in a normal state and outputs the gate ON/OFF signal in synchronization with the gate clock signal CPV, it is possible to protect the gate IC 520 from damage and a normal image display can be achieved.

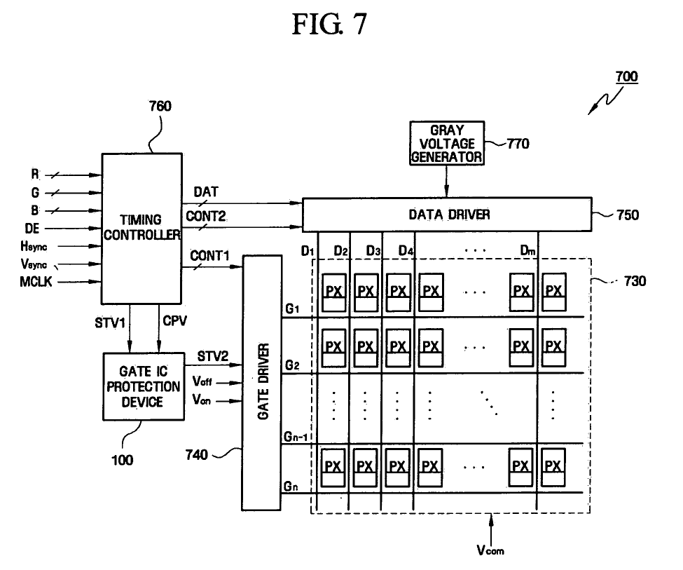

FIG. 7 is a block diagram of an LCD 700 according to an embodiment of the present invention.

Referring to FIG. 7, the LCD 700 includes a gate IC protection device 100, a liquid crystal panel assembly 730, a gate driver 740, a data driver 750, a timing controller 760, and a gray voltage generator 770. For convenience of explanation, detailed description of parts with reference numerals that are given to the elements performing the same functions as those shown in FIG. 2 will be omitted.

The liquid crystal panel assembly 730 includes a plurality of gate lines G1-Gn, a plurality of data lines D1-Dm, and a plurality of pixels PX connected thereto and arranged in a matrix.

The gate lines G1-Gn extend substantially in a row direction and are parallel to each other, while the data lines D1-Dm extend substantially in a column direction and are parallel to each other.

Meanwhile, for color display, each pixel PX uniquely represents a primary color (e.g., when using spatial division) or sequentially represents three primary colors in time (e.g., when using temporal division), thereby obtaining a desired color. Primary colors often include red (R), green (G) and blue (B).

The gate driver 740 receives gate ON/OFF voltages Von and Voff from a gate ON/OFF voltage generator (not shown). The gate driver 740, which is controlled by a gate control signal CONT1 provided from the timing controller 760 and a second vertical synchronization start signal STV2 provided from the gate IC protection device 100, applies the gate ON/OFF voltages Von and Voff supplied from the gate IC protection device 100 to the plurality of gate lines G1-Gn. Here, the gate control signal CONT1 includes a variety of signals for controlling the gate driver 740, excluding a first vertical synchronization start signal STV1 and a gate clock signal CPV.

The gate IC protection device 100 receives the first vertical synchronization start signal STV1 and the gate clock signal CPV from the timing controller 760, and provides the gate driver 740 with the second vertical synchronization start signal STV2. If the first vertical synchronization start signal STV1 is held high for a time period longer than 1H, the gate IC protection device 100 operates in such a manner that the second vertical synchronization start signal STV2 set at a low level is provided to the gate driver 740 to prevent the plurality of gate lines G1-Gn from being simultaneously turned on/off.

The data driver 750, which is connected to the data lines D1-Dm of the panel assembly 730, applies a plurality of data voltages to the data lines D1-Dm to the pixels PX. The data voltages are selected from gray voltages that are supplied by the gray voltage generator 770. Here, if the gray voltage generator 770 provides only a basic gray scale voltage rather than voltages for substantially all the grays scales, the data driver 750 may divide the basic gray voltage to then produce gray voltages for all gray scales for selection of data voltages among the produced gray voltages.

A difference between the data voltage applied to the pixel PX and a common voltage Vcom may serve as a pixel voltage. Liquid crystal molecules change their orientations according to pixel voltage and as a result, the polarization state of light passing through liquid crystal layer (not shown) changes. The displayed image also changes accordingly. The difference between the data voltage and the common voltage Vcom is represented as a voltage applied to the pixel PX, i.e., the pixel voltage. Liquid crystal molecules LC have orientations varying depending on the magnitude of the pixel voltage.

The timing controller 760 receives input image data RGB and input control signals for controlling a display of the RGB image data from an external graphic controller (not shown). Examples of the input control signals include a vertical synchronization signal V_{sync}, a horizontal synchronization signal H_{sync}, a main clock MCLK, a data enable signal DE, and so on.

The timing controller 760 generates a gate control signal CONT1 and a data control signal CONT2 from the input image data RGB and the input control signals and transmits the gate control signal CONT1 and the data control signal CONT2 to the data driver 750 and the gate driver 740, respectively. An image signal DATA is also transmitted to the gate driver 740.

The timing controller 760 and the gate IC protection device 100 may be installed on a single printed circuit board.

The gate driver 740 or the data driver 750 may be directly mounted on the liquid crystal panel assembly 730 as a plurality of driving integrated circuit chips or may be mounted on a flexible printed circuit (FPC) film (not shown) to then be attached to the liquid crystal panel assembly 730 as a tape carrier package.

The gray voltage generator 770 generates a plurality of gray voltage to provide the same to the data driver 750. Although not shown, the gray voltage generator 770 may comprise a plurality of resistors in series connected to one another between a node having a predetermined voltage applied thereto and a ground, and divides the predetermined voltage into multiple-level voltages to generate a plurality of gray voltages. The internal circuit of the gray voltage generator 770 may be embodied in various ways without being limited to the illustrated example.

As described above, even if the first vertical synchronization start signal STV1 received from the timing controller 760 is an abnormal signal, the LCD 700 can protect the gate IC from damage and a normal image display can be achieved.

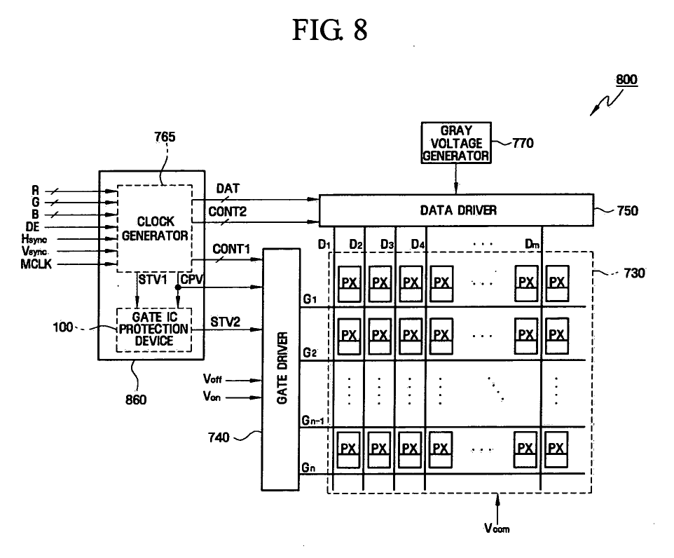

FIG. 8 is a block diagram of a liquid crystal display (LCD) 800 according to another embodiment of the present invention.

The LCD 800 according to the illustrated embodiment of the present invention is different from the LCD 700 shown in FIG. 7 in that a gate IC protection device 100 is incorporated into a timing controller 860. For convenience of explanation, detailed description of parts having the same reference numerals as the elements performing in FIGS. 2 and 7 will be omitted.

Referring to FIG. 8, the timing controller 860 includes a clock generator 765 producing a gate clock signal CPV and a first vertical synchronization start signal STV1, and a gate IC protection device 100 outputting a second vertical synchronization start signal STV2 of a low level when the first vertical synchronization start signal STV1 is held high for a time period longer than 1H.

In such an event, since the timing controller 860 provides the second vertical synchronization start signal STV2 being in a normal state, the gate IC can be protected from damage and a normal image can be displayed.

While the LCD according to the present invention has been described through a few preferred embodiments, the invention is not limited to the illustrated examples. LCDs having various configurations are contemplated. For example, the gate IC protection device 100 of FIG. 7 may be mounted on the gate driver 500 of FIG. 7. In other words, LCDs (not shown) may include the gate drivers 500 and 600 illustrated FIGS. 5 through 6.

As described above, the gate IC protection device, the gate driver and the LCD including the gate driver according to the present invention provide at least the following advantages.

First, even if a vertical synchronization start signal STV is abnormally held at a high level for a time period longer than 1H, the vertical synchronization start signal makes a proper transition at its logic level to be provided to the gate driver, thereby protecting the gate IC from being damaged due to an overcurrent condition.

Second, even if abnormal STV signal is input, as is turned on one time during a frame, normal image may be shown. Since each of a plurality of gate lines is turned on just once each in one frame, a normal image display can be achieved.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A gate integrated circuit (IC) protection device comprising:
a vertical synchronization start signal converting unit having:
a first input for receiving a first vertical synchronization start signal and a level control signal,
a logic circuit for performing a predetermined logic operation thereon, and
a first output for outputting a second vertical synchronization start signal; and
a signal delay unit having:
a second input for receiving the second vertical synchronization start signal and
a second output for outputting the level control signal that is fed back to the vertical synchronization start signal converting unit in synchronization with a gate clock signal.

2. The gate IC protection device of claim 1, wherein the vertical synchronization start signal converting unit comprises:
an inverter receiving the level control signal and outputting an inverted level control signal; and
an AND gate receiving the first vertical synchronization start signal and the inverted level control signal and outputting the second vertical synchronization start signal.

3. The gate IC protection device of claim 1, wherein the signal delay unit includes a D-flip-flop.

4. A gate driver comprising:
a vertical synchronization start signal converting unit having:
a first input for receiving a first vertical synchronization start signal and a level control signal,
a logic circuit for performing a predetermined logic operation thereon, and
a first output for outputting a second vertical synchronization start signal; and
a gate integrated circuit (IC) having:
a second input for receiving the second vertical synchronization start signal; and
a second output for outputting gate ON/OFF signals in synchronization with a gate clock signal, wherein one of the gate ON/OFF signals is fed back to the vertical synchronization start signal converting unit as the level control signal.

5. The gate driver of claim 4, wherein the gate IC comprises a plurality of D-flipflops, wherein each of the D-flipflops outputs the gate ON/OFF signals to one of the gate lines, and wherein one of the D-flipflops feeds the level control signal back to the vertical synchronization start signal converting unit in synchronization with to the gate clock signal.

6. The gate driver of claim 4, wherein the vertical synchronization start signal converting unit comprises:
an inverter receiving the level control signal and outputting an inverted level control signal; and
an AND gate receiving the first vertical synchronization start signal and the inverted level control signal and outputting the second vertical synchronization start signal.

7. A liquid crystal display (LCD) comprising:
a timing controller producing a first vertical synchronization start signal and a gate clock signal;
a gate IC protection device outputting a second vertical synchronization start signal of a logic low when the first vertical synchronization start signal is held high for more than a predetermined time period;
a gate driver receiving the second vertical synchronization start signal and outputting gate ON/OFF signals in synchronization with the gate clock signal; and
a liquid crystal panel assembly driving pixels using the gate ON/OFF signals and displaying a predetermined image.

8. The LCD of claim 7, wherein the gate IC protection device comprises:
a vertical synchronization start signal converting unit having:
a first input for receiving the first vertical synchronization start signal and a level control signal,
a logic circuit for performing a predetermined logic operation thereon, and
a first output for outputting the second vertical synchronization start signal, and
a signal delay unit having:
a second input for receiving the second vertical synchronization start signal, and
a second output for outputting the level control signal back that is fed back to the vertical synchronization start signal converting unit in synchronization with the gate clock signal.

9. The LCD of claim 8, wherein the vertical synchronization start signal converting unit comprises:
an inverter receiving the level control signal and outputting an inverted level control signal, and
an AND gate receiving the first vertical synchronization start signal and the inverted level control signal and outputting the second vertical synchronization start signal.

10. The LCD of claim 8, wherein the signal delay unit includes a D-flip-flop.

11. The LCD of claim 7, wherein the predetermined time period is a time taken for a gate line to be turned on.

12. A liquid crystal display (LCD) comprising:
a timing controller providing a first vertical synchronization start signal and a gate clock signal;
a gate driver including a gate IC protection device outputting a second vertical synchronization start signal of a logic low when the first vertical synchronization start signal is held high for more than a predetermined time period, and outputting gate ON/OFF signals in synchronization with the gate clock signal; and
a liquid crystal panel assembly driving pixels using the gate ON/OFF signals and displaying a predetermined image.

13. The LCD of claim 12, wherein the gate IC protection device comprises:
a vertical synchronization start signal converting unit having:
a first input for receiving the first vertical synchronization start signal and a level control signal,
a logic circuit for performing a predetermined logic operation thereon, and
a first output for outputting the second vertical synchronization start signal, and
a signal delay unit having:
a second input for receiving the second vertical synchronization start signal; and
a second output for outputting the level control signal that is back to the vertical synchronization start signal converting unit in synchronization with the gate clock signal.

14. The LCD of claim 13, wherein the vertical synchronization start signal converting unit comprises:
an inverter receiving the level control signal and outputting an inverted level control signal; and
an AND gate receiving the first vertical synchronization start signal and the inverted level control signal and outputting the second vertical synchronization start signal.

15. The LCD of claim 14, wherein the gate driver comprises a plurality of D-flipflops, wherein each of the D-flipflops outputs the gate ON/OFF signals to one of gate lines, and wherein the signal delay unit includes one of the D-flip-flops.

16. The LCD of claim 12, wherein the predetermined time period is a time taken for a gate line to be turned on.

17. A liquid crystal display (LCD) comprising:
a timing controller including a clock generator producing a gate clock signal and a first vertical synchronization start signal, and a gate IC protection device outputting a second vertical synchronization start signal of a logic low when the first vertical synchronization start signal is held high for more than a predetermined time period;
a gate driver receiving the second vertical synchronization start signal and outputting gate ON/OFF signals in synchronization with the gate clock signal; and
a liquid crystal panel assembly driving pixels using the gate ON/OFF signals and displaying a predetermined image.

18. The LCD of claim 17, wherein the gate IC protection device comprises:
a vertical synchronization start signal converting unit having:
a first input for receiving the first vertical synchronization start signal and a level control signal,
a logic circuit for performing a predetermined logic operation thereon, and
a first output for outputting the second vertical synchronization start signal; and
a signal delay unit having:
a second input for receiving the second vertical synchronization start signal; and
a second output for outputting the level control signal that is fed back to the vertical synchronization start signal converting unit in synchronization with the gate clock signal.

19. The LCD of claim 18, wherein the vertical synchronization start signal converting unit comprises:
an inverter receiving the level controls signal and outputting an inverted level control signal, and
an AND gate receiving the first vertical synchronization start signal and the inverted level control signal and outputting the second vertical synchronization start signal.

20. The LCD of claim 18, wherein the signal delay unit includes a D-flip-flop.

21. The LCD of claim 17, wherein the predetermined time period is a time taken for a gate line to be turned on.

22. A method of protecting a gate IC in a display device, the method comprising:
receiving a first vertical synchronization signal and a level control signal; and
performing a logic operation on the first vertical synchronization start signal and the level control signal to generate a second vertical synchronization start signal;
wherein the level control signal is generated using the second synchronization start signal.
